(19) United States
(12) Patent Application Publication
(10) Pub. No.: US 2014/0071568 A1
(43) Pub. Date: Mar. 13, 2014

(54) DC Power Source Isolation with Diode and Bypass Switch

(71) Applicants: Julius Michael Liptak, Knightdale, NC (US); Mark John Kocher, Raleigh, NC (US); George Edmund Burke, Raleigh, NC (US)

(72) Inventors: Julius Michael Liptak, Knightdale, NC (US); Mark John Kocher, Raleigh, NC (US); George Edmund Burke, Raleigh, NC (US)

(21) Appl. No.: 13/664,760

(22) Filed: Oct. 31, 2012

Related U.S. Application Data
(60) Provisional application No. 61/698,758, filed on Sep. 10, 2012.

(51) Int. Cl. H02H 9/02

(52) U.S. Cl. 361/57

(57) ABSTRACT

A protection circuit for an alternative energy source comprises a primary path including an isolation element, e.g., diode or transistor, to prevent current backflow into the alternative energy source from the power device. A low resistance bypass path around the isolation element is also provided. In a protection mode, the bypass path is opened so current must flow through the primary path. In a bypass mode, the bypass path is closed to provide a low resistance path for current to flow from the alternative energy source to the power device.

### RELATED APPLICATION

This application claims the benefit of U. S. Provisional Patent Application Ser. No. 61/698758 filed Sep. 10, 2012, which is incorporated herein by reference.

### BACKGROUND

The present invention generally relates to protection circuits for alternative energy power sources and, more particularly, to a protection circuit including a bypass to reduce energy losses during normal operation of the alternative energy source.

A blocking or isolation diode is typically included in series between an alternative energy power source and the input of a power device, such as a power converter or energy storage device. The alternative energy source 12 could be a fuel cell, storage battery, wind or steam turbine, photovoltaic array, or any other source that provides DC power to the input 18 of the power device. The purpose of the isolation diode is to prevent backflow of current into the alternative energy source when the source is not energized that could potentially damage the alternative energy source, particularly in the case where the alternative energy source is a fuel cell. While protecting the alternative energy source from damage, the presence of the isolation diode leads to increased energy losses during normal operation of the alternative energy source. The increased losses are particularly onerous in low voltage systems, and can lead to degradation in system efficiency of up to five percent.

### SUMMARY

The present disclosure describes various bypass arrangements that reduce the series voltage drop associated with the isolation diode during normal operation of the alternative energy source. The bypass arrangement retains the advantage of preventing backflow to the alternative energy source when the current output is low, but actively creates a low resistance path between the alternative energy source and a power device when the current output is high. As a result, the efficiency degradation associated with the isolation diode is greatly reduced.

Exemplary embodiments of the invention comprise a power supply circuit for protecting an alternative energy source. In one exemplary embodiment, the power supply circuit comprises an alternative energy source for generating a DC output, a power device connected to the output of the alternative energy source, and a protection circuit disposed between the alternative energy source and the power device. The protection circuit comprises a primary path including an isolation element to prevent current backflow from the power device to the alternative energy source along the primary path, and a bypass path configured to prevent current flow when the protection circuit is configured in the protection mode and to allow current flow around the isolation element when the protection circuit is in a bypass mode.

Other embodiments of the invention provide a method of controlling a power supply circuit to reduce energy losses. The power supply circuit includes a primary path having an isolation element to prevent current backflow and a bypass path. In one exemplary method the current at an input to the power device is monitored and either a protection mode or bypass mode is selected based on the current. In the protection mode, the protection circuit is configured to prevent current flow around the isolation element through the bypass path. In the bypass mode, the protection circuit is configured to allow current flow around the isolation element through the bypass path.

Still other embodiments of the invention comprise a protection circuit for an alternative energy source. In one embodiment, the protection circuit comprises a primary path including an isolation element to prevent current backflow into said alternative energy source along the primary path, and a bypass path in parallel with the primary path to enable current flow around the isolation element in a bypass mode and to prevent current flow around the isolation element in a protection mode.

### BRIEF DESCRIPTION OF THE DRAWINGS

FIG. 1 illustrates a known power supply circuit.

FIG. 2 illustrates an exemplary protection circuit according to a first embodiment.

FIG. 3 illustrates an exemplary protection circuit according to a second embodiment.

FIG. 4 illustrates an exemplary method for controlling a protection circuit with a bypass path to reduce conduction losses.

FIG. 5 illustrates another exemplary method for controlling a protection circuit with a bypass path to reduce conduction losses.

### DETAILED DESCRIPTION

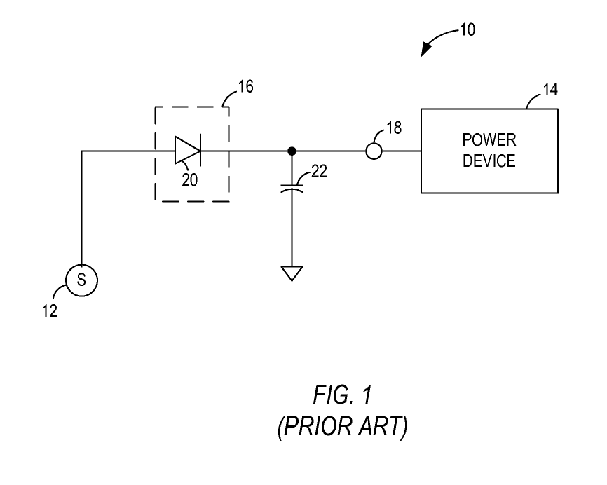

Referring now to the drawings, FIG. 1 illustrates a conventional power supply circuit 10. The power supply circuit 10 includes an alternative energy source 12, power device 14, and protection circuit 16. The alternative energy source 12 could be a fuel cell, storage battery, wind or steam turbine, photovoltaic array, or any other source that provides DC power to the input 18 of the power device 14. The power device 14 comprises a device that converts power and/or stores energy. The power device 14 may, for example, comprise a power converter that converts the DC power at its input 18 to provide AC power at its output. In some embodiments, the power device 14 may comprise an energy storage device, such as a battery or large capacitor.

The protection circuit 16 comprises a blocking diode 20 connected in series between the alternative energy source 12 and the input 18 to the power device 14 to prevent the backflow of current from the power device 14 to the alternative energy source 12. In some embodiments, an optional shunt capacitor 22 may be connected between the protection circuit 16 and the power device 14.

While providing protection for the alternative energy source 12, the presence of the blocking diode 20 in the protection circuit 16 results in series conduction losses due to voltage drop across the blocking diode 20. In exemplary embodiments of the present invention, means are provided for bypassing the blocking diode 20 when the current flowing from the alternative energy source 12 reaches a predetermined level in order to reduce the series conduction losses.

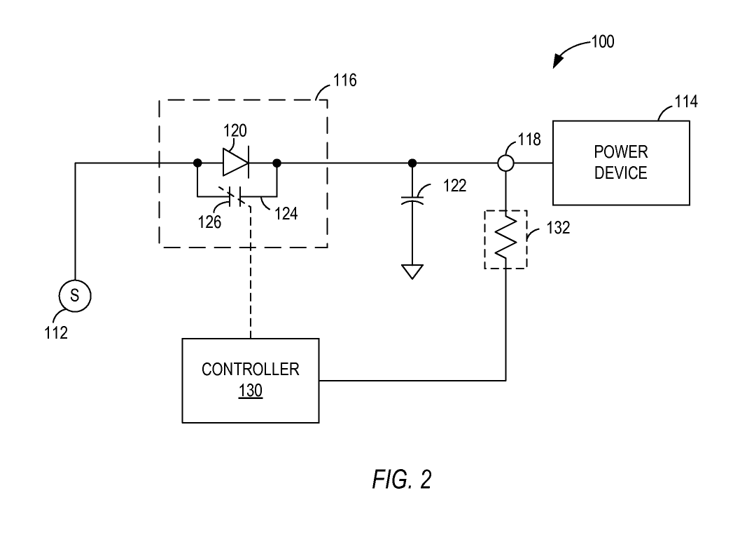

FIG. 2 illustrates a power supply circuit 100 according to one embodiment of the invention. The power supply circuit 100 comprises a protection circuit 116 according to one embodiment of the invention. The power supply circuit 100 includes an alternative energy source 112, power device 114, and protection circuit 116. The alternative energy source supplies DC power to the input 118 of the power device 114. The protection circuit 116, as previously described, prevents the backflow of current into the alternative energy source 112 when it is not energized.

The protection circuit 116 in this embodiment includes a blocking diode 120, and a bypass path 124 including a switching element 126. The blocking diode 120 is connected along a primary path in series between the alternative energy source 112 and the input 118 of the power device 114. The bypass path 124 provides a low resistance current path for current flowing from the alternative energy source 112 to the input 118 of the power device 114as will be hereinafter described. The switching element 126 is connected in parallel with the blocking diode 120. The switching element 126 may comprise, for example, a contactor or latching relay. In some embodiments, an optional shunt capacitor 122 may be connected between the protection circuit 116 and the power device 14.

When the switching element 126 is closed, current may flow around the blocking diode 120 through the bypass path 124. This mode is referred to herein as the bypass mode. When the switching element 126 is open, current is prevented from flowing through the bypass path 124. This mode is referred to as the protection mode.

Switching element 126 is actuated by a controller 130. A sensor 132 monitors the current at the input 118 of the power device 114and provides a signal to the controller 130. When the current level at the input 118 is low, controller 130 generates a control signal to open the switching element 126. When the switching element 126 is open, blocking diode 120 blocks the steady state or transient backflow of current into the alternative energy source 112. At higher input current levels, e.g., when there is no current backflow due to transient conditions, the controller 130 may close the switching element 126 to provide a low resistance current path between the alternative energy source 112 and the input 118 of the power device 114. In this case, the current flows from the alternative energy source 112 to the input 118 of the power device 114through the bypass circuit 124.

The bypass path 124 provides a much lower series voltage drop than the primary path across diode 120, e.g., millivolts instead of volts. Therefore, a significant reduction in series conduction loss may be realized. When a contactor is used as the switching element 126, the reductions realized by reducing the series conduction loss are partially offset by the power required to energize the coil of the contactor. To further reduce the coil loss, a latching relay could be used if other system constraints allow the use of such a latching device.

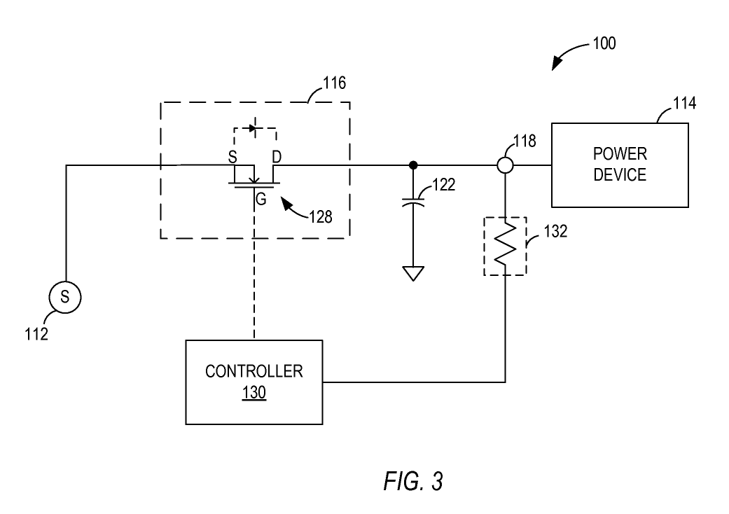

FIG. 3 illustrates a power supply circuit 100 including a protection circuit 116 according to another embodiment. The power supply circuit 100 includes an alternative energy source 112, power device 114, and protection circuit 116. In this embodiment, the protection circuit 116 includes a power MOSFET 128. The power MOSFET 128 replaces the blocking diode 120 and switching element 126 in the first embodiment shown in FIG. 2. The power MOSFET 128 acts like a synchronous rectifier. The power MOSFET 128 includes two internal current paths between the source and drain of the MOSFET. A primary path includes an internal diode inherent to the structure of the MOSFET that functions as the isolation element to block the backflow of current. A bypass path circumvents the internal diode. A sensor 132 measures the current at the input 118 of the power device 114, and a controller 130 controls the power MOSFET 128 based on the measured current level. An optional shunt capacitor 22 may be connected between the protection circuit 16 and the power device 14.

At low current levels, the controller 130 generates a control signal to inhibit the gate of the power MOSFET 128. When the gate of the power MOSFET 128 is inhibited, the MOSFET's intrinsic diode performs the current blocking function. At higher current levels, the controller 130 enables the gate of the power MOSFET. The conduction losses when the gate is enabled are much lower than when the current flows through the MOSFET internal diode.

It may be noted that the embodiments shown in FIGS. 2 and 3 are similar in that both provide a low resistance bypass path to circumvent an isolation element. In the embodiment shown in FIG. 2, the bypass path 124 circumvents the blocking diode 120. In the embodiment shown in FIG. 3, the bypass path in the transistor between the source and drain when the gate is enabled circumvents the intrinsic diode in the primary path of the MOSFET 128. In both embodiments, a driver circuit, e.g., controller 130 and sensor 132, must be supplied to enable the bypass mode of operation.

The embodiment shown in FIG. 2 has the advantage of lower series voltage drop, but requires a modest amount of power to energize a coil of the contactor. The contactor's coil is inherently isolated and may therefore be conveniently referenced to any supply voltage. Contactors are available in a variety of coil voltages, further simplifying the selection of the driver for the contactor coil.

The MOSFET 128 typically has a higher series voltage drop, but does not require as much power to maintain the bypass path open. The MOSFET 128 requires a gate driver/power supply arrangement that is referenced to the positive terminal of the alternative energy source. The MOSFET 128 has the additional benefit of combining the isolation device and bypass into a single physical component, which is typically smaller than a similarly-rated contactor.

In a typical implementation, e.g., a power converter with 100 amps input current, the full load conduction losses associated with the blocking diode 120 are about 100 watts. Thus, the total power loss using a protection circuit 116 according to the prior art (FIG. 1) would be about 100 watts. In the embodiment shown in FIG. 2, the conduction loss in the bypass mode would be reduced to less than 30 watts, while the contactor coil power would require less than 5 watts to operate. Thus, the protection circuit 116 of FIG. 2 reduces power losses relative to the conventional protection circuit of FIG. 1 by approximately 65 watts. The embodiment shown in FIG. 3, can reduce the power losses relative to the conventional protection circuit of FIG. 1 by 30-50 watts. These losses could be further reduced by using a MOSFET with greater die area.

In both embodiments shown in FIGS. 2 and 3, the controller 130 must ensure that the bypass mode is only activated at current levels sufficiently high to eliminate the possibility of transient backflow current to the alternative energy source 112. At start up, controller 130 will generate a control signal to keep the protection circuit 116 in a protection mode so that backflow of current is prevented. As the input current to the power device 114 rises above a predetermined threshold, controller 130 may place the protection circuit 116 in a bypass mode. Conversely, when the input current falls below the threshold, the controller 130 generates a control signal to return the protection circuit 116 to the protection mode. Thus, controller 130 must constantly monitor the input current to the power device 114and control the protection circuit 116 accordingly.

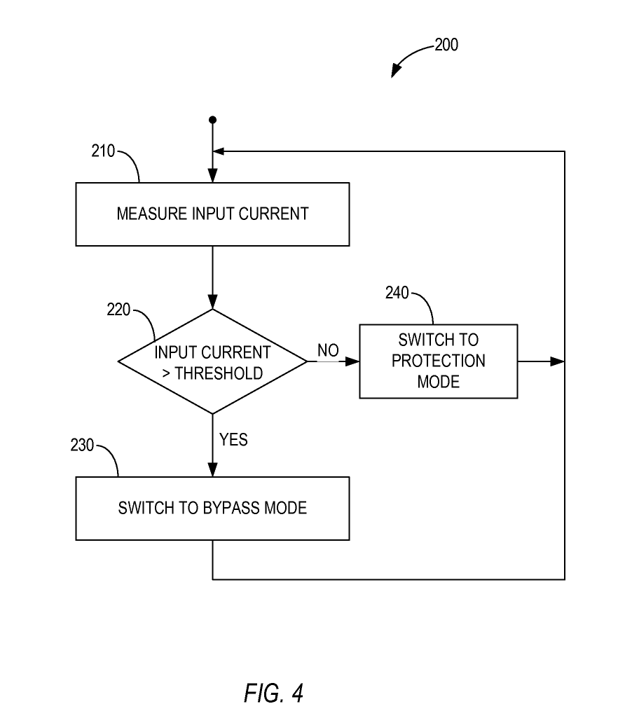

FIG. 4 illustrates an exemplary control method 200 implemented by the controller 130. Controller 130 (FIGS. 2 and 3) continuously monitors the input current (block 210) and compares the input current to a threshold (block 220). If the input current is greater than the threshold, the controller 130 generates a control signal to switch the protection circuit 116 to a bypass mode (block 230). If, on the other hand, the input current is less than the threshold, the controller 130 generates a control signal to switch the protection circuit 116 to a protection mode (block 240).

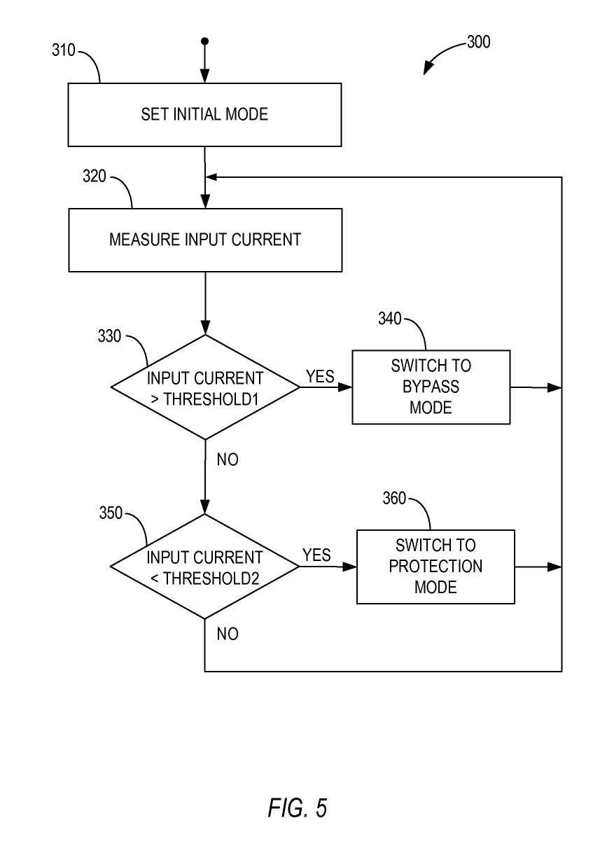

FIG. 5 illustrates another exemplary control method 300 implemented by controller 30. Controller 30 (FIGS. 2 and 3) during startup sets the initial mode (i.e., protection or bypass) based on a programmed preference or on the previous state of the controller 30 prior to shutdown (block 310). Immediately, controller 30 begins monitoring the input current (block 320) and compares the current level to a first threshold (Threshold1) (block 330) and, as required, to a second threshold (Threshold2) (block 350). Threshold1 is greater than or equal to Threshold2. If the input current is greater than Threshold1, the controller 30 selects the bypass mode (block 340). If the input current is less than Threshold2, the controller 30 selects the protection mode (block 360). If the current falls between the limits of Threshold1 and Threshold2, then no mode change occurs. This embodiment incorporates hysteresis into the control function. This is advantageous in that unnecessary cycling between modes can be avoided.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A power supply circuit comprising:
an alternative energy source for generating a DC output;
a power device connected to the output of the alternative energy source; and
a protection circuit disposed between the alternative energy source and the
power device, said protection circuit comprising:
a primary path including an isolation element configured to prevent current backflow from the power device to the alternative energy source along the primary path in a protection mode; and
a bypass path configured to prevent current flow through the bypass path when the protection circuit is configured in a protection mode and to allow current flow through the bypass path when the protection circuit is in a bypass mode.

2. The power supply circuit according to claim 1 further comprising a controller configured to:
monitor the input current to the power device; and
switch the protection circuit responsive to changes in the input current, said switching being between the protection mode to direct current flow through the primary path and the bypass mode to enable current flow through the bypass path.

3. The power supply circuit according to claim 2 wherein the controller is configured to compare the input current to a threshold and to switch the protection circuit to the protection mode when the input current is below a threshold.

4. The power supply circuit according to claim 2 wherein the controller is configured to compare the input current to a threshold and to switch the protection circuit to the bypass mode when the input current is above a threshold.

5. The power supply circuit according to claim 1 wherein the protection circuit includes a blocking diode disposed along the primary path and a switching element disposed along the bypass path, wherein the switching element is configured to open the bypass path in the protection mode and to close the bypass path in the bypass mode.

6. The power supply circuit according to claim 5 wherein the switching element comprises a contactor.

7. The power supply of claim 5 wherein the switching element comprises a latching relay.

8. The power supply circuit according to claim 1 wherein the protection circuit comprises a MOSFET connected in series between the alternative energy source and the power device, wherein the MOSFET includes a source, a drain, a primary path connecting the source and the drain, and a bypass path connecting the source and the drain.

9. The power supply circuit according to claim 8 wherein the MOSFET circuit includes a gate for opening the bypass path in the protection mode and closing the bypass path in the bypass mode.

10. In a power supply circuit comprising an alternative energy source, a power device, and a protection circuit, said protection circuit including a primary path having an isolation element to prevent current backflow, a method of reducing energy losses comprising:
providing a low resistance bypass path around the isolation element;
monitoring an input current to said power device;
selecting one of a protection mode and a bypass mode depending on the input current;
configuring the protection circuit in the protection mode to allow current flow through the primary path and prevent current flow through the bypass path; and
configuring the protection circuit in the bypass mode to allow current flow around the isolation element through the bypass path.

11. The method of claim 10 wherein selecting one of the protection mode and the bypass mode depending on the input current comprises:
selecting the protection mode when the input current is lower than a threshold; and
selecting the bypass mode when the current is greater than the threshold.

12. The method of claim 10 wherein:
configuring the protection circuit in the protection mode comprises opening a contactor in the bypass path to prevent current flow along the bypass path; and
configuring the protection circuit in the bypass mode comprises closing the contactor in the bypass path to allow current flow along the bypass path.

13. The method of claim 10 wherein the protection circuit comprises a MOSFET with an isolation element and wherein:
configuring the protection circuit in the protection mode comprises controlling a signal to a gate of the MOSFET to open the bypass path; and
configuring the protection circuit in the bypass mode comprises controlling a signal to a gate of the MOSFET to close the bypass path.

14. A protection circuit for an alternative energy source, said protection circuit comprising:
a primary path including an isolation element configured to prevent current backflow into said alternative energy source along the primary path; and
a bypass path in parallel with the primary path configured to enable current flow around the isolation element in a bypass mode and to prevent current flow around the isolation element in a bypass mode.

15. The protection circuit according to claim 14 wherein the protection circuit comprises a blocking diode disposed along the primary path and a switching element disposed along the bypass path, wherein the switching element is configured to open the bypass path in the protection mode and to close the bypass path in the bypass mode.

16. The protection circuit according to claim 15 wherein the switching element comprises a contactor.

17. The protection circuit according to claim 15 wherein the switching element comprises a latching relay.

18. The protection circuit according to claim 14 wherein the protection circuit comprises a MOSFET connected in series between the alternative energy source and the power device, wherein the MOSFET includes a source, a drain, a primary path connecting the source and the drain, and a bypass path connecting the source and the drain.

19. The protection circuit according to claim 18 wherein the MOSFET circuit includes a gate for opening the bypass path in the protection mode and closing the bypass path in the bypass mode.
